(19) United States
(12) Patent Application Publication
(10) Pub. No.: US 2026/0217054 A1
(43) Pub. Date: Jul. 30, 2026

(54) ELECTRIC GRAVER HANDPIECE

(71) Applicant: Glendo LLC, Emporia, KS (US)

(72) Inventors: Thomas D. Koch, Emporia, KS (US); Adam Grundleger, Emporia, KS (US); Mark F. Valentine, Emporia, KS (US)

(21) Appl. No.: 19/457,834

(22) Filed: Jan. 23, 2026

Related U.S. Application Data
(60) Provisional application No. 63/751,017, filed on Jan. 29, 2025.

(51) Int. Cl. B44B 3/00

(52) U.S. Cl. CPC B44B 3/005; B44B 3/009; B44B 2700/045

(57) ABSTRACT

A graver handpiece and methods of operation of the graver handpiece are disclosed. The graver handpiece comprises a solenoid configured to generate a magnetic field when energized. The magnetic field may interact with a plunger and a magnet coupled to the plunger imparting a force on the plunger to move the plunger from a starting position to a striking position. Based on the force, the plunger strikes an impact plate transferring at least a portion of the force to a stylus to engrave an engraving material. The graver handpiece further comprises a spring to restore the plunger to the starting position. Furthermore, the graver handpiece may efficiently pull heat from the solenoid allowing the graver handpiece to be entirely metal. Furthermore, a startup operation of the graver handpiece provides smooth operation and comfortable handling for an operator.

### RELATED APPLICATIONS

This application is a non-provisional patent application of U.S. Provisional and claim benefit of priority to Patent application 63/751,017, filed January 29, 2025, the disclosure of which is incorporated in its entirety herein by reference.

### BACKGROUND

### 1. FIELD

Embodiments of the current disclosure relate to a graver handpiece. More specifically, embodiments of the current disclosure relate to an all-metal graver handpiece with smooth startup operations.

### 2. RELATED ART

Generally, electric gravers are used to engrave various materials. Electric energy is provided to a solenoid to move a plunger that strikes an anvil causing a stylus to impact the engraving material. However, solenoids heat up during operation. Typical gravers require large heat sinks and insulation material between the heat sink and handles. Typical gravers include plastic or wood handles to help insulate the operator’s hand from the heat. Even so, these gravers can heat up becoming uncomfortably hot during extended use. Furthermore, if the solenoid becomes too hot, the strike force of the plunger on the anvil diminishes. Furthermore, typical gravers including plastic or wood handles are less durable than metal gravers and less desirable by operators.

Typical gravers comprising push-type solenoids have a jarring and uncomfortable startup sequence. Typical plungers start from an initial position at a distance from the intermediate impact device and accelerate to impacting the intermediate impact device. The startup process of accelerating the plunger from zero to impact of typical handpieces results in an undesirable jarring effect of the handpiece in the operator’s hand. The startup process of typical gravers is undesirable, abrupt, and can adversely affect the engraving process.

What is needed are systems and methods of providing a smooth startup sequence and providing an all-metal graver with high durability, relatively low temperatures, and limited loss of strike force.

### SUMMARY

Embodiments of the current disclosure solve the above-described problems and provide a distinct advance in the art by providing a graver handpiece configured to provide smooth startup, low heat generation, and efficient heat dissipation.

An embodiment of the current disclosure is directed to a graver handpiece for engraving. The graver handpiece comprises a solenoid configured to generate a magnetic field when energized, a plunger positioned adjacent to the solenoid, a magnet coupled to a back end of the plunger, and wherein the plunger is configured to accelerate toward an intermediate impact device under a force imparted on the plunger by the magnetic field of the solenoid, and wherein the plunger is configured to strike the intermediate impact device transferring at least a portion of the force to the intermediate impact device for engraving.

An embodiment of the current disclosure is direct to a method of operating a graver handpiece. The method comprises receiving a drive pulse by a solenoid, generating a magnetic field by the solenoid based on the drive pulse, imparting a force onto a plunger by the magnetic field, estimating an impact time of the plunger, eliminating the magnetic field at or near the impact time based on an input from a hand control or a pedal, and forcing the plunger away from an intermediate impact device by a spring force from a spring coupled to the plunger.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an embodiment of a graver system;

FIG. 2 depicts an embodiment of a graver handpiece;

FIGS. 3A-3C depict cross-section views of an embodiment of the graver handpiece;

FIG. 4 depicts an embodiment of the graver handpiece with a circuit;

FIG. 5 depicts the graver handpiece and an alternative assembly system;

FIGS. 6A-6B depict an exemplary embodiment of the graver handpiece with a strike plate;

FIG. 7 depicts the graver handpiece comprising a hand control sensor;

FIGS. 8A-8C depict a first exemplary startup option for embodiments of the graver handpiece;

FIGS. 9A-9D depict a first exemplary shutdown option for embodiments of the graver handpiece;

FIG. 10 depicts exemplary magnetic fields generated by an embodiment of the graver handpiece;

FIGS. 11A-11D depict a second exemplary startup option for embodiments of the graver handpiece;

FIG. 12A-12D depict a second exemplary shutdown option for embodiments of the graver handpiece;

FIG. 13 depicts an exemplary drive pulse diagram for embodiments of the graver handpiece;

FIG. 14 depicts a flow diagram illustrating an exemplary startup method of the graver handpiece;

FIG. 15 depicts a flow diagram illustrating a method of operation of the graver handpiece; and

FIG. 16 depicts a flow diagram illustrating a method of operation of the alternative embodiment of the graver handpiece.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following description of embodiments of the invention references the accompanying illustrations that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense.

In this description, references to “one embodiment”, “an embodiment”, “embodiments”, “various embodiments”, “certain embodiments”, “some embodiments”, or “other embodiments” mean that the feature or features being referred to are included in at least one embodiment of the technology. Separate references to “one embodiment”, “an embodiment”, “embodiments”, “various embodiments”, “certain embodiments”, “some embodiments”, or “other embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the current technology can include a variety of combinations and/or integrations of the embodiments described herein.

Generally, embodiments of the current disclosure provide a graver handpiece configured to provide comfortable temperatures and smooth startup. In some embodiments, the graver handpiece comprises a solenoid configured to generate a magnetic field when energized. The magnetic field may interact with a plunger and a magnet coupled to the plunger imparting a force on the plunger to move the plunger from a starting position to a striking position. Based on the force, the plunger strikes an intermediate impact device transferring at least a portion of the force to a stylus to engrave an engraving material. Furthermore, the graver handpiece comprises a spring to restore the plunger to the starting position.

In some embodiments, the graver handpiece is entirely metal, efficiently pulling heat from the solenoid. The heat may also be pulled from the interior of the handpiece by allowing heated air to be transferred through vents in the housing. As the plunger cycles from the starting position to the striking position and back, the plunger may act as a piston forcing hot air out of and pulling cool air into the handpiece. Furthermore, various startup operations of the graver handpiece provide smooth operation and comfortable handling for an operator and are disclosed herein.

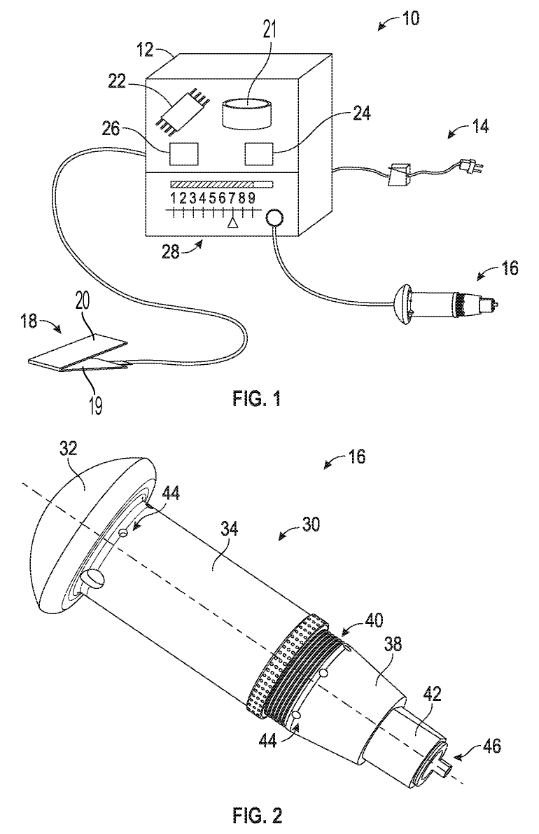

FIG. 1 depicts an exemplary embodiment of graver system 10 comprising control box 12, electric plug 14, handpiece 16 including control sensor 19, and foot pedal 18 also including control sensor 19, in some embodiments. In some embodiments, control box 12 comprises non-transitory computer-readable media storing computer-executable instructions that, when executed by at least one processor 22, perform the methods described herein. Particularly, the instructions may be executed to provide electric drive pulses to handpiece 16 to perform startup procedures and engraving procedures. Control box 12 may be operable to control any and all functions of handpiece 16 described below. Furthermore, control box 12 may be powered by electricity provided by electric plug 14. Electric plug 14 may connect with any standard outlet and provide power to control box 12. Furthermore, in some embodiments, control box 12 may comprise a battery providing power to operate control box 12 and handpiece 16. In some embodiments, control box 12 is operable to provide a low power output to handpiece 16; however, any power required by handpiece 16 may be generated by control box 12 as described below.

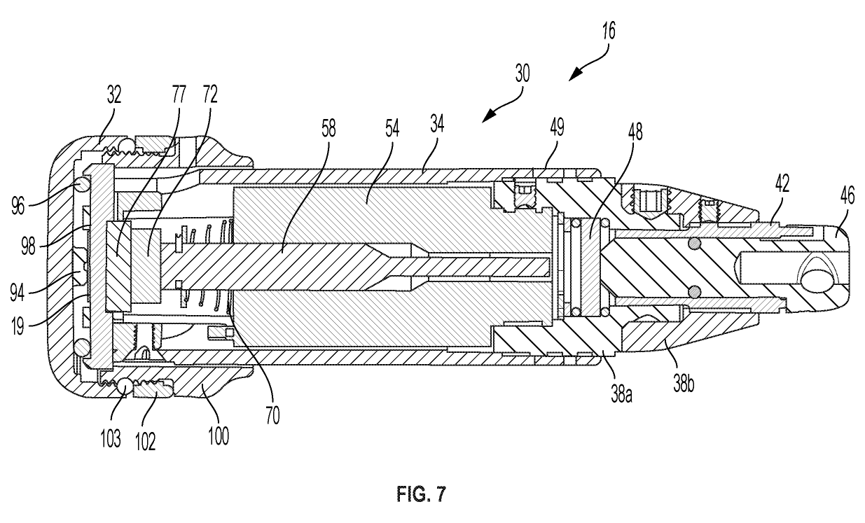

In some embodiments, foot pedal 18 including control sensor 19 (FIG. 7) may be operable to provide signals indicative of desired power that may then be transformed by at least one processor 22 executing the instructions stored on memory 21 to provide the drive pulses to alter the engraving power of handpiece 16 based on the position of the foot pedal 18 or back cap 32 (FIG. 7), or force applied to control sensor 19. For example, foot pedal 18 may start in a foot pedal starting position. As another example, control sensor 19 may start in a no pressure position. In the foot pedal starting position, the drive pulse signals may not be provided to handpiece 16, but a startup signal may be provided. In the control sensor 19 starting condition, the drive pulse signals may not be provided to handpiece 16, but a similar or same startup signal may be provided. The startup signals may keep solenoid 54 energized pushing plunger 58 to intermediate impact device 48 (e.g., anvil, impact plate, stylus connector 46) in a startup process initial position. As the foot pedal 18 and/or back cap 32 is depressed by an operator, the drive pulses may be provided to handpiece 16 and the startup signal may be slowly reduced. Once the position of foot pedal 18 or back cap 32 is provided beyond a specified position, or the force applied to the control sensor 19 exceeds a certain value, the startup signal can be eliminated and only the drive pulses are transmitted to solenoid 54 for normal operation of handpiece 16. The startup procedure and the normal operation of handpiece 16 are described in detail below.

To provide the drive pulses and the startup signals to handpiece 16, control box 12 includes standard electronic components such as processor 22, memory 21, DC to DC converter 24, as well as various electronic components 26, which may comprise circuits, communication components, passive components, leads, as well as any other standard electronic components. Here, control box 12 is configured to store instructions, receive inputs by foot pedal 18, or control sensor 19, and face controls 28 (setting power output and frequency settings) and output signals to control handpiece 16. Data from the DC-to-DC converter 24 can be combined with data from pedal deflection and the various components that control the handpiece 16 to estimate and monitor electrical power consumption in the handpiece 16, which can be used for control or special brief high-power modes of operation, or to indicate when self-heating is reducing the nominal steady power output of the handpiece 16. In some embodiments, control box 12 is any standard control box in the industry programmed and/or configured to perform the functions described herein.

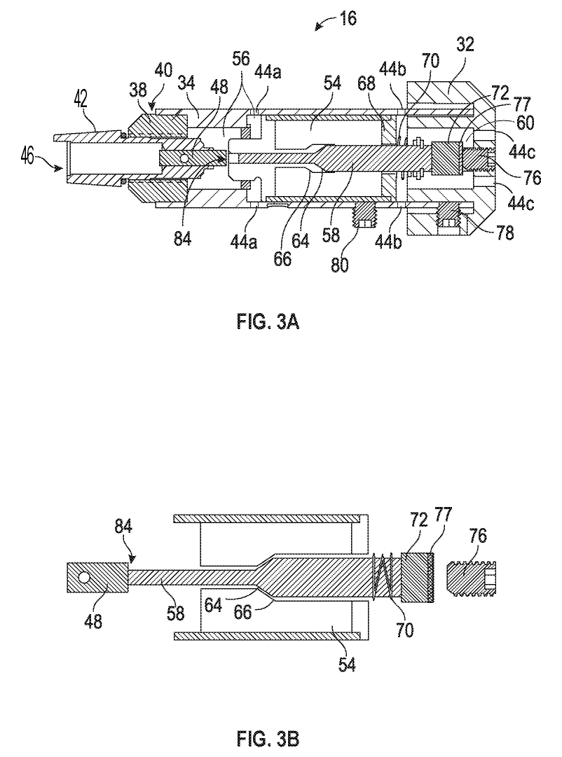

FIG. 2 depicts an exemplary embodiment of handpiece 16 comprising handpiece housing 30. In some embodiments, handpiece housing 30 comprises metal, wood, plastic, and the like. However, in some embodiments described herein, handpiece housing 30 is all metal. An all-metal handpiece housing 30 allows for heat dissipation while held in the hand, and, less efficiently, while in free air, such that the operator can handle handpiece 16 without discomfort. It is well known that most operators prefer metal handpieces over plastic and wood and that temperatures of electric handpieces typically become uncomfortably high during prolonged operation. The configurations of handpiece 16 described below, allow handpiece 16 including handpiece housing 30 to be made of all metal while maintaining comfortable temperatures. In some embodiments, handpiece housing 30 may comprise aluminum, steel, stainless steel, or any other metal or metal alloy. In some embodiments, part or all of the metals must be non-magnetic.

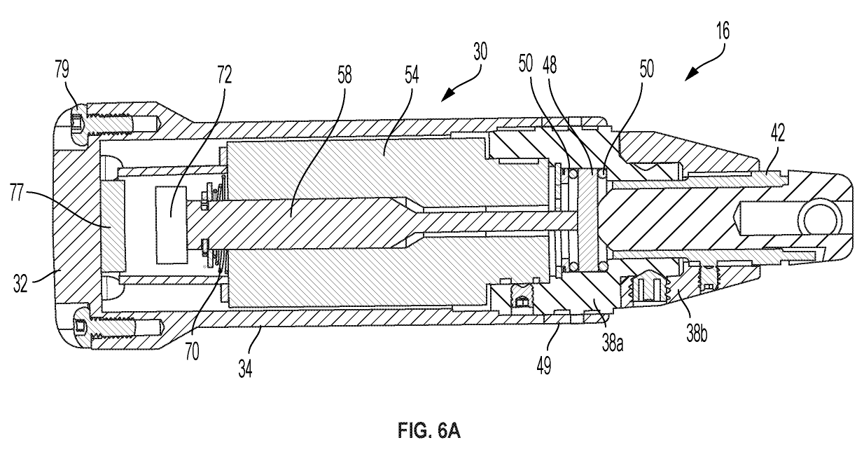

In some embodiments, handpiece housing 30 comprises back cap 32 including control sensor 19, central housing 34 comprising central housing threads (FIG. 5), intermediate housing 38 comprising intermediate housing threads 40, stylus tube 42, and vent holes 44. Here, as described above, all components may be metal. The metal components may act as a heat sink dissipating heat from the interior of handpiece 16 to the air exterior of handpiece 16, or the user’s hand while holding handpiece 16. Furthermore, as described below, vent holes 44 connect the exterior of handpiece housing 30 to the interior of handpiece housing 30. Specifically, vent holes 44 connect plunger interior space to the exterior of handpiece 16 and are configured to vent air between the plunger interior space and the exterior of the handpiece. Vent holes 44 are described in detail below.

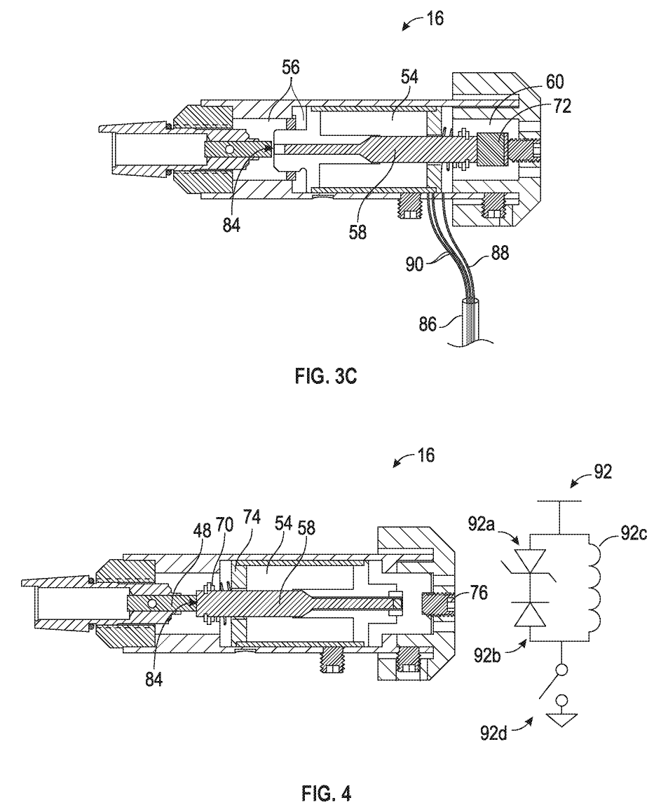

FIGS. 3A-3C depict cross-section of an exemplary embodiment of graver handpiece 16 illustrating interior components of handpiece 16. In some embodiments, intermediate housing 38 may be coupled to central housing 34 by threading intermediate housing threads 40 into central housing threads or vice versa. Though not shown here, it can be imagined that central housing threads are complimentary to intermediate housing threads 40. The threads here are exemplary, and in some embodiments, intermediate housing 38 may be coupled to central housing 34 using set screws, screws, bolts, welding, adhesives, and the like. Similarly, in some embodiments, back cap 32 may be coupled to central housing 34 by set screw 78 as shown in FIG. 3A, or any other method listed above. Furthermore, stylus tube 42 may be coupled to intermediate housing 38 by threads and/or set screws, screws, bolts, adhesives, welding, and the like. In some embodiments, back cap 32 and stylus tube 42 may be snapped into place by interior levers. Furthermore, stylus connector 46 may be configured to receive a stylus and, as plunger 58 strikes intermediate impact device 48, the energy is transferred to the stylus for engraving various engraving materials.

Generally, handpiece 16 is operational to engrave various surfaces comprising, wood, metal, plastic, and the like depending on operational parameters and the stylus connected to stylus connector 46. Handpiece 16 may be held by an operator and the operator may also operate control box 12 and foot pedal 18 to provide power, drive pulses, and startup signals to handpiece 16. As described above, the operator may press foot pedal 18 or back cap 32 to control the signals transmitted to handpiece 16. As such, the operator may control the startup and operation procedures of handpiece 16 described below.

In the embodiment depicted in FIGS. 3A-3C, as power is provided to solenoid 54, solenoid 54 may provide a magnetic field that imparts a push force on plunger 58 to push plunger 58 into intermediate impact device 48 as shown in FIG. 3B referenced herein as the striking position. Power may then be removed, and plunger 58 may then be restored to the starting position as shown in FIG. 3A. The push force here is provided by solenoid 54, and the restoration force is provided by spring 70; however, in some embodiments, a push/pull solenoid, or a pull-type solenoid may be provided. Here, the entire push/pull cycle may occur in a range of time durations. As such, a strike force from plunger 58 impacting intermediate impact device 48 may occur in a range of frequencies. For example, the push/pull cycle may be accomplished in 1/40 of a second leading to 40 impacts per second. Similarly, or alternatively, the impact rate may be 30, 35, 45, 50, or any other times below, above, or in between these rates. Though an impact rate of 40 impacts per second is referenced herein, it should be understood that this is exemplary, and any impact rate may be achieved. As described in more detail below, achieving these cycle rates is possible because of several components of handpiece 16 working together in coordination.

In some embodiments, solenoid 54 may be relatively low powered as compared to some standard solenoids used in the industry. For example, the power output from control box 12 may be approximately 3.5, 4.0, 4.2, 4.5, 4.8, 5.0 or the like Watts. Here, the power output is exemplary and, it should be understood that any power output to achieve the desired impact time and power can be applied. The relatively low power may reduce heat generated by solenoid 54 adding to the ability for handpiece 16 to be all metal and making handpiece 16 comfortable for the user to hold in some embodiments. Furthermore, the average input power over time may be intentionally limited by providing the drive pulses as short powerful pulses to solenoid 54. Furthermore, based on the input power, solenoid 54 may provide any desired force. The input power and the strike force may be adjustable by adjusting control box 12 and changing the foot pedal position, the hand control sensor applied force, and settings as operable by the operator described above.

In some embodiments, drive pulses are provided to the solenoid 54 as controlled by the at least one processor 22 of control box 12. The computer-executable instructions may be configured, when executed by at least one processor 22, to provide short pulses of electrical energy (herein “drive pulses”) to the solenoid 54 by the power source of control box 12. When solenoid 54 receives the electrical energy, solenoid 54 is energized creating the magnetic field around solenoid 54. The magnetic field interacts with plunger 58, which in some embodiments is a magnetically interactive material, to accelerate plunger 58 from the start position (FIG. 3A) into the strike position (FIG. 3B). In some embodiments, the drive pulses may be provided at a certain frequency to cause plunger 58 to be forced to strike intermediate impact device 48 at the same frequency.

In some embodiments, solenoid 54 is configured to force plunger 58 from the start position (FIG. 3A) to the strike position (FIG. 3B). In the start position, plunger 58 may be pulled back by spring 70 until magnet 72 contacts dampening material 77, made of a rubber, plastic, composite, or other material, and back cap screw 76 inside back cap 32. Magnet 72, in some embodiments, interacts with back cap screw 76 to pull/hold plunger 58 back against back cap screw 76 in the start position. It should also be noted, that in the start position shown in FIG. 3A, spring 70 ideally imparts no, or little, force on plunger 58. At this point, spring 70 is at, or close to, its natural unloaded configuration. As such, the only force imparted on plunger 58 may be the magnetic force based on the magnetic attraction between magnet 72 and back cap screw 76. As such, plunger 58 is allowed to remain in the start position without any opposition force. It should also be noted that the “start position” referenced herein is exemplary as a reference position to describe the normal cyclic operation of handpiece 16.

Furthermore, as spring 70 is in the natural resting state, when solenoid 54 causes plunger 58 to overcome the magnetic force and move toward intermediate impact device 48, spring 70 may only provide a small resistive force to the motion of plunger 58. This small resistive force may increase as plunger 58 nears intermediate impact device 48 based on a carefully selected spring constant of spring 70. As such, once plunger 58 strikes intermediate impact device 48 and solenoid power is removed, spring 70 (coupled to plunger 58 and solenoid wall 68) may provide the restorative force to return plunger 58 and magnet 72 to back cap screw 76 in the start position. In some embodiments, spring 70 may be a conical spring configured to be strong enough to return plunger 58 to the start position but not too strong to significantly reduce acceleration of plunger 58 and to not significantly reduce the strike force of the plunger 58 on intermediate impact device 48.

To further optimize strike impact, when the drive pulse is provided to solenoid 54, the magnetic field provided by solenoid 54 may interact with magnet 72. In some embodiments, magnet 72 may be provided at the back end of plunger 58 on the back cap side of handpiece 16. Furthermore, magnet 72 may be coupled to plunger 58 such that magnet 72 moves with plunger 58. In some embodiments, magnet 72 may comprise a rare-earth magnet such as, for example, neodymium and/or samarium cobalt magnets. As magnet 72 is coupled to the back end of plunger 58, plunger 58 may further protect magnet 72 from impact forces of plunger 58 striking intermediate impact device 48. Generally, rare-earth magnets may not be configured to withstand direct impact forces, which may be present in the normal operation of handpiece 16. However, because magnet 72, in this embodiment, is positioned at the back side of plunger 58, magnet 72 is protected from the impact forces.

In some embodiments, poles of magnet 72 may be aligned with the solenoid magnetic field providing an additional force to plunger 58. As solenoid 54 is energized, the resulting magnetic field may impart a force on magnet 72. So, not only is the solenoid magnetic field acting upon plunger 58 to force plunger 58 from the start position to the strike position, but magnet 72 connected to the back end of plunger 58 may also interact with the magnetic field providing an additional force and further accelerating plunger 58 toward intermediate impact device 48.

Furthermore, to aid in optimizing strike force, sidewall set screw 80 may adjust a solenoid fore-aft position of solenoid 54. The fore-aft position of solenoid 54 may be important in providing optimal force with which plunger 58 strikes intermediate impact device 48. Furthermore, in some embodiments, solenoid 54 comprises solenoid angled face 66 and plunger 58 comprises a corresponding plunger angled face 64, having corresponding angles with respect to the fore-aft axis of the solenoid. Solenoid 54 can be adjusted such that plunger angled face 64 and solenoid angled face 66 are as close as possible in the strike position. In the strike position shown in FIG. 3B, plunger 58 is striking intermediate impact device 48 (which may or may not be present) and plunger angled face 64 is extremely close to but not touching solenoid angled face 66. Because plunger angled face 64 and solenoid angled face 66 are close and because the plunger angled face 64 and solenoid angled face 66, the maximum force is imparted to plunger 58 with all, or nearly all, of the force then being transferred to intermediate impact device 48 and stylus connector 46 and on to the stylus. Furthermore, the travel/strike distance may be adjusted by adjusting central housing 34 relative to intermediate housing threads 40 as described above. Furthermore, the travel/strike distance may be adjusted by adjusting the location of lock ring 49.

With the various forces described herein acting on plunger 58 across the travel distance from start position to strike position, the travel distance (and timing) may be adjusted by back cap screw 76 to further optimize the strike force on the intermediate impact device 48 at strike point 84. As described above, plunger 58 strikes intermediate impact device 48 at a high strike rate, in some embodiments. As such, the starting position of plunger 58 is crucial in the operation of handpiece 16. If plunger 58 is set too far back (i.e., toward the back cap 32) plunger 58 will travel farther from the start position to the strike position, resulting in a longer travel time to impact and potentially reduced strike force. Furthermore, if the travel time is too long, operation may not reach the desired cycles per second (e.g., 40 strikes per second). Additionally, if the travel time/distance is too long the strike force may be reduced. The strike force may be reduced by reduced force applied by solenoid 54, by de-energizing solenoid 54 before plunger 58 is near or at strike point 84, and/or by spring 70 being stretched beyond expectation. As such, under these conditions, handpiece 16 may operate sub optimally.

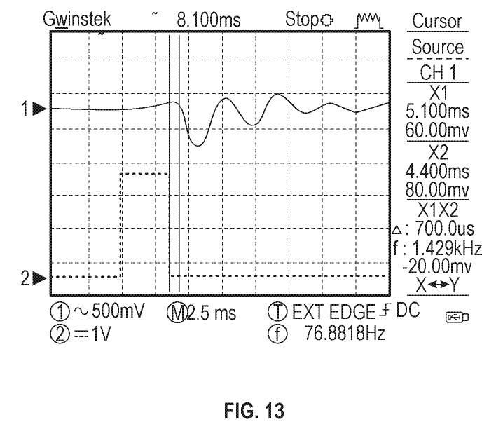

To provide the optimal strike force based on plunger 58 striking intermediate impact device 48 at strike point 84 with the above-described forces acting on plunger 58, the starting position of plunger 58 can be adjusted by back cap screw 76. Back cap screw 76 and dampening material 77 provided in back cap 32, may provide an adjustable starting position for plunger 58. In some embodiments, back cap screw 76 comprises a set screw, a bolt, a screw, or simply a spacer that may be adjustable. Back cap screw 76 may be adjusted by twisting to move inward toward the interior of handpiece 16 and twisting the opposite direction to move outward toward the exterior of handpiece 16. As such, the starting position, and therefore the travel distance from start position to strike position, of plunger 58 may be adjusted. In some embodiments, back cap screw 76 is set such that the impact between plunger 58 and intermediate impact device 48 occurs shortly after the end of the electric drive pulse as shown in FIG. 13. Furthermore, in some embodiments, back cap screw 76 may comprise magnetically interactive material such that there exists a slight magnetic interaction with magnet 72. The magnetic force between back cap screw 76 may slightly assist in the restoring force, particularly when spring 70 is near its natural state as described above. Furthermore, as spring 70 may impart little-to-no force on plunger 58 when in the starting position, the force between magnet 72 and back cap screw 76 may assist in holding plunger 58 in the start position.

In some embodiments, back cap screw 76 may be cushioned by dampening material 77. Dampening material 77 may provide energy absorption between back cap screw 76 and magnet 72 such that when plunger 58 is restored to the starting position by spring 70, the small impact between magnet 72 and back cap screw 76 is cushioned. The energy absorption may aid in softening the impact between back cap screw 76 and magnet 72 but also may cushion the impact felt by the operator when operating handpiece 16, particularly during the startup process described below. Dampening material 77 may also dampen the impact between plunger 58 and the back cap screw 76, reducing sputtering or bi-modal operation of the motion of plunger 58.

As described above, handpiece 16 may be configured to be all metal while also being comfortable to hold by the operator. As such, various heat dissipation techniques are provided. In some embodiments, as described above, vent holes 44 may be provided to assist in cooling handpiece 16. Vent holes 44 may be provided through sidewall of housing 30 and in some embodiments, through back cap 32 of housing 30. In some embodiments, the motion of plunger 58 acts like a driving piston that can move air through vent holes 44 to aid in cooling. As plunger 58 moves from the starting position to striking position, plunger 58 may force hot air (air that has absorbed heat energy from solenoid 54) out of sidewall vent holes 44a and pull cool air in from the exterior of handpiece 16 into back cap chamber 60 through aft sidewall holes 44b and/or back cap holes 44c. Similarly, or alternatively, as spring restoring force pulls plunger 58 from striking position back to starting position, hot air in back cap chamber may be forced out of back cap holes 44c and aft sidewall vent holes 44b while cool air from the exterior of handpiece 16 is pulled into solenoid chamber 56 through sidewall vent holes 44a. Therefore, as plunger 58 is performing high impact rates, air is constantly drawn in and forced out of the interior of handpiece 16 to move heat away from solenoid 54 and out of handpiece 16.

In some embodiments, handpiece 16 may further be cooled by forced air. FIG. 3C depicts the handpiece shown in FIGS. 3A-3B comprising forced air hose 88. Here, bundle 86 comprises power wires 90 and air hose 88. Power wires 90 may be connected to control box 12 and provide the drive pulses and the startup signals described below. Furthermore, air hose 88 may be connected to control box 12, which in some embodiments, comprises an air compressor, a fan, or the like. In some embodiments, air hose 88 is not connected to control box 12 but may be connected to an auxiliary air supply. Air may be forced into back cap chamber 60 by air hose 88. As plunger 58 cycles as described above, heated air may be forced out through vent holes 44 and cool air may be forced into back cap chamber 60 by air hose 88. In some embodiments, vent holes 44 are not present and forced air in a closed system, with a supply hose and a return hose, may cool solenoid chamber 56 and back cap chamber 60 to allow a full metal housing without losing efficiency in solenoid 54 and while maintaining comfort for the operator.

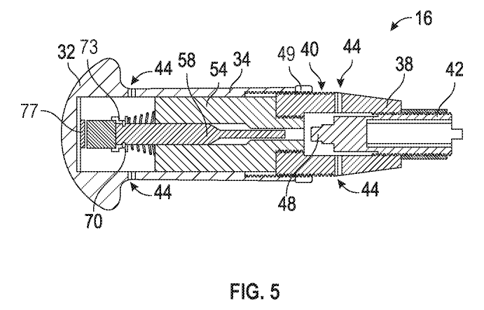

FIG. 4 depicts an alternative embodiment of handpiece 16 where solenoid 54 is energized to force plunger 58 aft. In some embodiments, spring 70 is compressed between the connection between plunger 58 and forward solenoid wall 74. As energy is released by removing the drive pulse, spring 70 provides the strike force on intermediate impact device 48. Here, plunger 58 is inverted from handpiece 16 depicted in FIGS. 3A-3C and spring 70 is provided on the forward side of plunger 58. The configuration of handpiece 16 in FIG. 4 is similar to that of FIGS. 3A-3C in that the solenoid 54 can be adjusted by sidewall set screw 80 and plunger 58 start position, and transition length and time may be adjusted by back cap screw 76. Furthermore, cycle operation may be the same as described above. Short, high-power drive pulses may be provided to solenoid 54 to operate handpiece 16. Furthermore, startup operations described below may also apply to handpiece 16 depicted in FIG. 4.

As drive pulses are provided to energize solenoid 54 in FIG. 4, solenoid 54 generates the magnetic field described above. Here, the starting position of plunger 58 is forward in contact with intermediate impact device 48. There may be no or limited magnetic attraction between intermediate impact device 48 and the plunger 58. As plunger 58 interacts with the magnetic field provided by solenoid 54, the force is applied to plunger 58 moving plunger 58 aft toward back cap screw 76. In some embodiments, just before, at, or after plunger 58 contacts back cap screw 76, drive pulse may stop, eliminating magnetic field, and spring force provided by spring 70 takes over. The timing of turning off the magnetic field may be based at least in part on an estimated time for plunger 58 to contact intermediate impact device 48. Spring 70 may expand back to its natural coiled shape pulling plunger 58 back until plunger 58 strikes intermediate impact device 48 imparting the energy from plunger 58 to intermediate impact device 48 and transferring on to the stylus to engrave the engraving material.

In some embodiments, for spring-driven solenoid, as illustrated in FIG. 4 and described above, the current in solenoid coil 92c of solenoid 54 must be removed relatively quickly after drive pulse is removed. The quick removal of the current in solenoid coil 92c can be removed utilizing circuit 92 shown in FIG. 4. In some embodiments, a Zener or TVS diode 92a may be utilized with a silicon or Schottky diode 92b along with control switch 92d as shown. Because the release event for the current is relatively short, the heating of solenoid 54 mainly occurs when current is applied. The kinetic energy of plunger 58 and the mechanical work performed by solenoid 54 acting on spring 70 through plunger 58 can be transferred into spring 70 with high efficiency. When spring 70 expands, nearly all of the potential energy stored in the compressed spring 70 can be transferred to plunger 58 in the form of the kinetic energy with which plunger 58 strikes the anvil. Because, in some embodiments, solenoid 54 is not pushing against spring 70 during the anvil strike and because solenoid 54 does not need to drive plunger 58 at high speed when plunger 58 compresses the spring and because solenoid 54 has a relatively long period of time to perform the described actions, the configuration is relatively efficient, and does not require a permanent magnet to be attached to plunger 58. Furthermore, because plunger 58 can be initially in full contact with the anvil during the startup process, the startup is exceptionally smooth and does not require a special startup signal.

FIG. 5 depicts an exemplary embodiment of handpiece 16. Here, handpiece 16 provides an alternative method of setting the plunger 58 travel distance from start position to strike position. As illustrated in FIG. 5, handpiece 16 is in start position with plunger 58 a distance from intermediate impact device 48. Spring 70 may be positioned at an aft end of plunger 58 inside back cap 32. As solenoid 54 is energized, plunger 58 may be forced toward intermediate impact device 48 compressing spring 70 to provide a restoring force as described above in reference to FIGS. 3A-3C. As described above and below, back cap screw 76 in FIGS. 3A to 3C, sets the distance between plunger 58 and intermediate impact device 48. Here, in FIG. 5, the distance may be set by threading intermediate housing 38 into central housing 34. Intermediate housing 38 may be locked in place by intermediate housing lock ring 49 once the position of intermediate housing 38 is determined by the calibration process described below. As with the implementation shown in FIG. 2, the exemplary handpiece 16 in FIG. 5 includes control sensor 19 (FIG. 7) integrated into back cap 32 or into dampening material (e.g., dampening material 77), which can be useful for the plunger travel calibration process described below. Placement of control sensor 19 is possible because back cap 32, here, does not have a set screw like the back caps shown in FIG. 3A to 3C.

Continuing with the embodiment depicted in FIG. 5, an exemplary configuration of magnet bracket 73 is provided. Magnet bracket 73 could be any configuration that prevents magnet 72 from sliding along the surface of plunger 58 due to the forces present during operation. The exemplary embodiment of magnet bracket 73 illustrated in FIG. 5 is a ring comprising two different diameters. The first diameter provides the ring around plunger 58 and the second diameter provides the ring around magnet 72. The ring may be a snap ring, or the like, and is coupled to plunger 58. As such, during operation the magnet 72 is held to the plunger 58 longitudinally by magnetic attraction and magnet 72 is prevented from sliding laterally by magnet bracket 73. Furthermore, as described above, magnet bracket 73 may be any configuration and may be based on the size and location of magnet 72 positioned in plunger 58. A post formed on the head of plunger 58, and the use of a ring magnet with a hole diameter and magnet thickness that matches the post, wherein the post extends through the hole of the ring magnet, can be used as an alternative to magnet bracket 73.

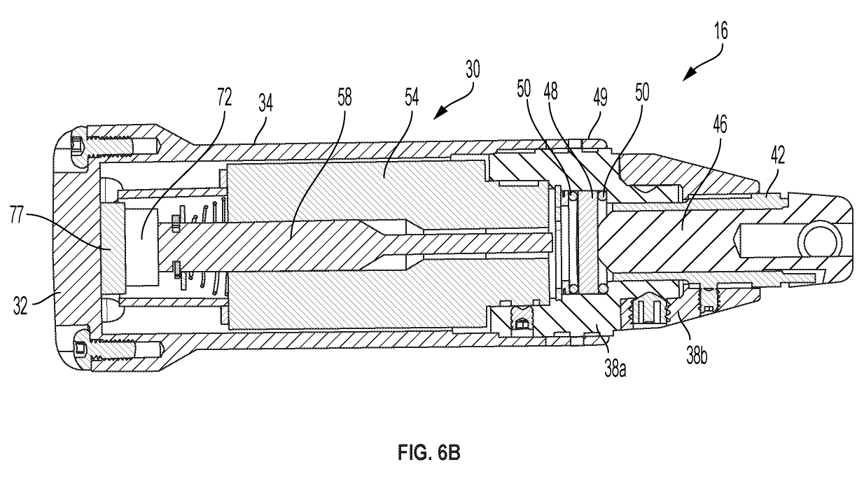

FIGS. 6A and 6B illustrate an embodiment of handpiece 16 configured with intermediate impact device 48 and in an impact position (FIG. 6A) and a retracted position (FIG. 6B). As described in embodiments herein, plunger 58 may be operated in a cyclic process by the combination of solenoid 54 and spring 70 and by an operator controlling control pedal 18 and/or control sensor 19. As illustrated in FIGS. 6A and 6B, pedal 18 provides control signals to solenoid 54. However, in some embodiments, control sensor 19 may be used as illustrated in FIG. 7 and discussed in more detail below. Furthermore, as described herein related to the configuration shown in FIGS. 6A and 6B, solenoid 54 provides impact motion (e.g., moving the plunger 58 from the retracted position to the impact position and spring 70 provides a restorative force retracting plunger 58 from the impact position to the retracted position).

Furthermore, as described in embodiments above, handpiece 16 comprises dampening material 77 provided at the rear end of the handpiece 16 at back cap 32. Dampening material 77 may be any rubber, plastic, metal, or the like, and may be configured to receive plunger 58 when plunger 58 is retracted back to the retracted position illustrated in FIG. 6B. Dampening material 77 may provide cushion between back cap 32 and plunger 58. Furthermore, in some embodiments, magnet 72 may be attracted to dampening material 77 to assist in the return to the retracted position. Furthermore, as described above, handpiece 16 may additionally comprise vent holes to allow cooling of the interior of handpiece 16 while plunger 58 is cycling between the strike position in FIG. 6A and the retracted position in FIG. 6B.

The travel distance between strike position in FIG. 6A and the retracted position in FIG. 6B may be set based on the calibration process described below and may be mechanically set by adjusting the position of back cap 32 using central housing 34 and lock ring 49. Central housing 34 may be adjusted inward to reduce the travel distance and adjusted outward to increase the travel distance and then locked in position using lock ring 49. As described above, the travel distance is set to optimize the timing and force of impact of plunger 58 on intermediate impact device 48 to optimize stylus operation and engraving during operation. As described in embodiments herein, the time to impact sets the timing of the on/off switch of the magnetic field, which optimizes impact, timing, and reduces heating of solenoid 54. As such, setting the travel distance is important in optimal operation and is described in detail below.

Some embodiments, handpiece 16, as illustrated in FIGS. 6A-6B and FIG. 7, includes intermediate impact device 48. In general, intermediate impact device 48 provides similar functionality as described above. For example, as described above, intermediate impact device 48 is an anvil attached, in some embodiments, to plunger 58 or to stylus connector 46. In some embodiments, intermediate impact device 48 may be configured as a circular plate (FIGS. 6A-6B, FIG. 7) with strike rings 50 disposed at various locations around intermediate impact device 48 to position intermediate impact device 48.

Intermediate impact device 48 may be provided between plunger 58 and stylus connector 46 and may be held in position by strike rings 50. In some embodiments, intermediate impact device 48 may be positioned to contact stylus connector 46. As such, when plunger 58 strikes intermediate impact device 48, maximum energy is transferred from plunger 58 to stylus connector 46. Furthermore, the impact may be mitigated by a selected design amount by strike rings 50, which may be compressible O-rings comprising, rubber, plastic, composite, or the like. As such, strike rings 50 may hold intermediate impact device 48 in the desired position illustrated in FIGS. 6A-6B and FIG. 7 and compress when plunger 58 strikes intermediate impact device 48 transferring the strike energy from plunger 58 to stylus connector 46. In some embodiments, intermediate impact device 48 may not be provided between plunger 58 and stylus connector 46, and plunger 58 may directly impact stylus connector 46.

Furthermore, in some embodiments, spring 70 comprises a reducing diameter spiral configuration as illustrated in FIGS. 3A-3C, FIG. 4, FIG. 5, FIG. 6A-6B, and FIG. 7. In some embodiments, when spring 70 is compressed as shown in FIG. 6A, spring 70 may compress to a single wire width comprising concentric circles allowing plunger 58 to impact intermediate impact device 48 or stylus connector 46. The configuration of spring 70 is to provide a collapsing spring, reduce spring weight and spring resistance, eliminate rubbing between adjacent coils, and decrease the overall length of handpiece 16.

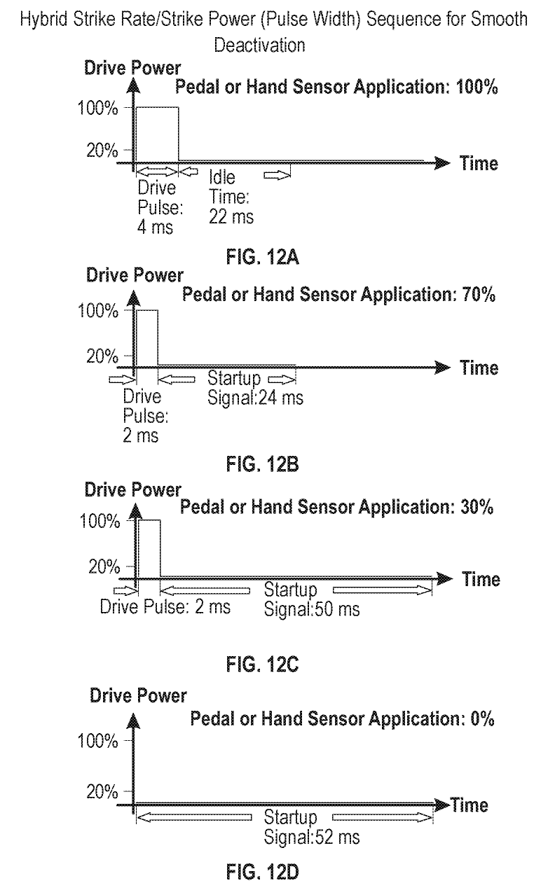

FIG. 7 illustrates the configuration of handpiece 16 shown in FIGS. 6A and 6B modified to be operable by control sensor 19. Control sensor 19, shown in FIG. 7, may be used to calibrate handpiece 16 (for example, when a new solenoid is installed) by providing real-time feedback needed to select the optimal distance between intermediate housing 38 and central housing 34 described above in regard to FIGS. 3A-3C, FIG. 4, and FIG. 5 and similarly between back cap 32 and intermediate housing 38 in FIG. 7. The calibration process to adjust the back cap 32 and/or back cap screw 76 to set the travel distance may be the same or very similar between all embodiments. In the calibration process, the at least one processor 22 compares the phase relationship of the drive pulse to the reaction pulse output from the control sensor 19. The at least one processor 22 then calculates the adjustment needed to provide the optimal strike force and instructs the user to adjust the handpiece 16 accordingly. The user can simply hold the handpiece 16 with one hand and press on the back cap 32 with a finger from the other hand and then activate the handpiece 16 for free-running operation. This mechanical coupling provided by the user will allow the plunger impacts to be sensed by the control sensor 19, producing a reaction pulse that can be used in the processes described previously to calibrate the handpiece 16. An exemplary set of waveforms having a phase relationship that can be used for this tuning is shown in FIGS. 12A-12D and described below.

FIG. 7 depicts an exemplary embodiment of handpiece 16. In some embodiments, control sensor 19 is housed between back plate 98 and back cap 32 comprising back cap extension 94 configured to contact control sensor 19. Back cap rings 96 may be provided to prevent back cap extension 94 of back cap 32 from impacting control sensor 19 when force is not applied to back cap 32. In some embodiments, control sensor 19 may be configured to transmit a control signal indicative of the user-applied force to the at least one processor 22. To set the optimal position of magnet 72 based on the travel distance of plunger 58, central housing 34 may be adjusted to bring back plate 98 forward to obtain maximum strike force as shown in FIG. 6B. Once the desired position of back plate 98, central housing 34, and dampening material 77 is achieved, lock ring 49 may be secured to hold the position. As such, back plate 98 may be secured in the desired positioned such that plunger 58 slightly impacts dampening material 77 in the retracted position during cycles.

The adjustment to the position of back plate 98 relative to plunger 58 may also be performed when using control input from foot pedal 18 as described below. When using foot pedal 18 to calibrate handpiece 16, FIG. 3C and FIG. 5 will be referenced; however, any embodiment using foot pedal 18 as the control input for calibration can be used in this example. For example, intermediate housing 38 is split into fore and aft sections, fore section 38a and aft section 38b joined by set screws in the forward section engaging a groove in the aft section. The connection between the two sections of the intermediate housing 38 may be made using set screws, cams, levers, or any other adjustable joining method. The split intermediate housing allows the stylus tube 42 to be oriented at any angle relative to the central housing 34, advantageously allowing the user to select a preferred angle for the stylus relative to where power wires 90 (FIG. 3C) exit the handpiece 16 without affecting the calibrated distance between the plunger 58 and the intermediate impact device 48.

In some embodiments, solenoid 54 as well as plunger 58 and spring 70 and any connecting components thereof may be slid into housing 30. Intermediate housing 38 may be threaded into central housing 34 locking solenoid 54 and plunger 58 in place. Next, stylus tube 42 may be threaded into intermediate housing aft section 38b to provide intermediate impact device 48 at an optimal distance from plunger 58. When provided at the optimal distance, normal operation, as described above, may be performed. For example, when solenoid 54 is energized by a drive pulse, plunger 58 (and magnet 72) moves toward intermediate impact device 48 and strikes intermediate impact device 48 just before plunger 58 strikes solenoid 54. Therefore, nearly all of the energy provided to plunger 58 (and magnet 72) by solenoid 54 is provided to intermediate impact device 48. To optimize strike force, stylus tube 42 may be threaded in and out until strike force and time is optimized as described in embodiments below. As described above, the cycle here may be configured for 40 strikes per second at approximately 7 Newtons, though these values are exemplary, and any number of strikes and force may be considered for various engraving materials and engraving methods. Furthermore, as described above, housing 30 comprises sidewall vent holes 44 configured to dissipate heat from the interior of handpiece 16 as plunger 58 cycles.

In some embodiments, foot pedal 18 works similarly to, or the same as, handpiece control. The user input described in relation to the control sensor 19 may similarly be provided in the foot pedal 18 where the back cap 32 is equivalent to pedal 20 of the foot pedal 18 as control sensor 19 may be provided in foot pedal 18 as described above. As such, instead of the operator applying force to back cap 32 with their hand, the operator may apply force to the pedal 20 with their foot and generate the same, or similar, control signal to solenoid 54.

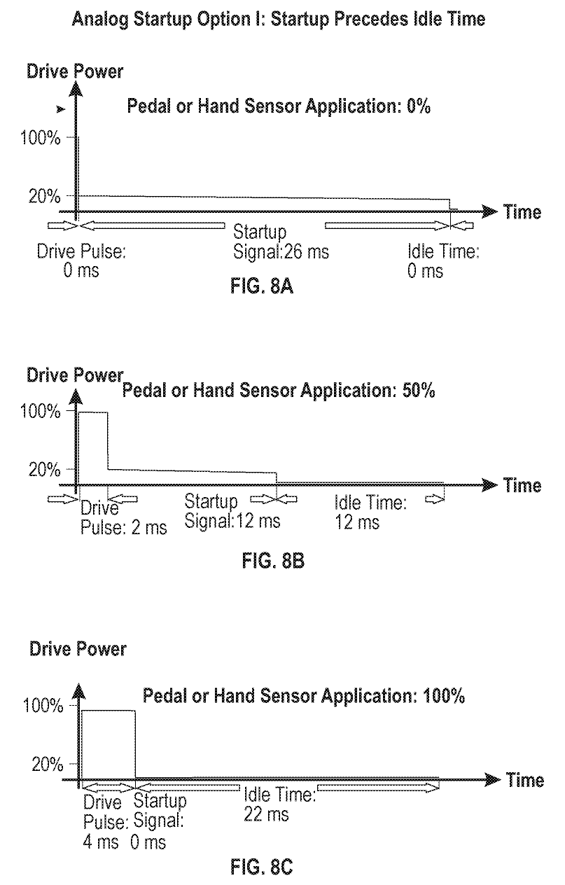

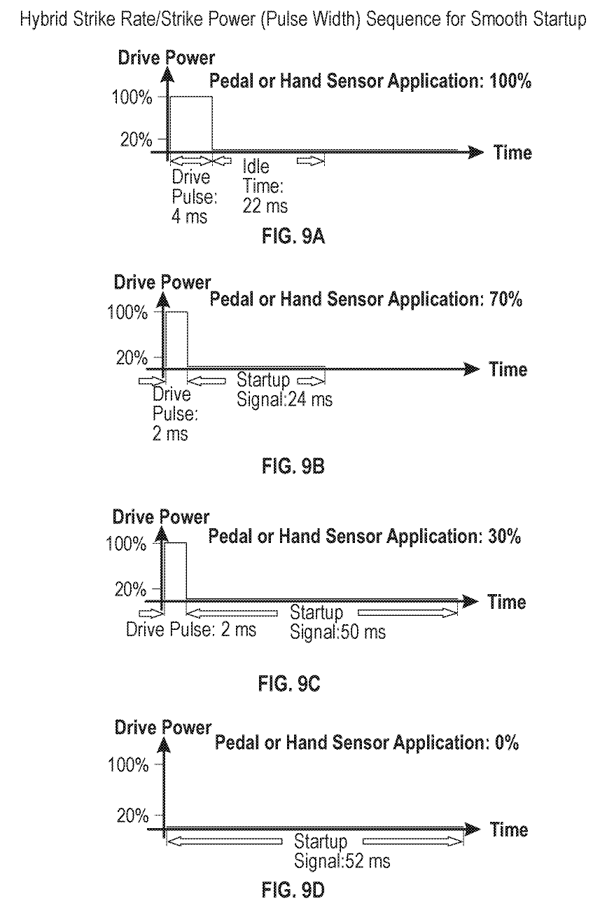

FIGS. 8A-8C, FIGS. 9A-9D, FIGS. 11A-11D, and FIGS. 12A-12D depict various embodiments of startup operations of graver system 10. Generally, in some embodiments, startup operation may provide a drive pulse to the solenoid 54 of handpiece 16. The drive pulse may generate a strong magnetic field that forces the plunger 58 to impact the intermediate impact device 48 (which may be an anvil, strike plate, or stylus connector 46 depending on the embodiment of handpiece 16) at high speed. The startup operation may provide an idle time, during which the solenoid 54 is not energized. The idle time allows the return spring in the solenoid 54 to push the plunger 58 away from the intermediate impact device 48. The startup signal is preceded by the drive pulse and followed by the idle time. Using a control process where the duration of the drive signal is based on a forecasted time of strike, the drive pulse is not applied any longer than necessary to reduce heat generation. During the startup operation, the drive pulse duration is increased from zero to its maximum value, the startup signal duration is decreased from its maximum value to zero, and the idle time duration is increased from zero to its maximum value. In response to the startup operation, the plunger 58 initially maintains contact with the intermediate impact device 48. Then, as the startup signal duration decreases and the idle time duration increases, the plunger 58 is lifted off the intermediate impact device 48 for increasing periods of time, and the plunger 58 reaches increasing distances from the intermediate impact device 48 at the end of each idle time. At the start of the drive pulse, the plunger 58 is driven back into the intermediate impact device 48 with speed that increases as the drive pulse duration increases. The startup process causes the plunger 58 to transition from full contact of the intermediate impact device 48 to partial contact of the intermediate impact device 48 with a continuously increasing striking force. During the entire startup process, the plunger 58 always strikes the anvil with a repetition rate defined by the user, regardless of the striking force. This means the sum of the respective durations for the drive pulse, the startup signal, and the idle time will be constant. The start-up operation described here is shown in FIGS. 8A-8C. An alternative sequence, which shows a drive pulse sequence that achieves smooth handpiece shutdown, shown in FIGS. 9A-9C.

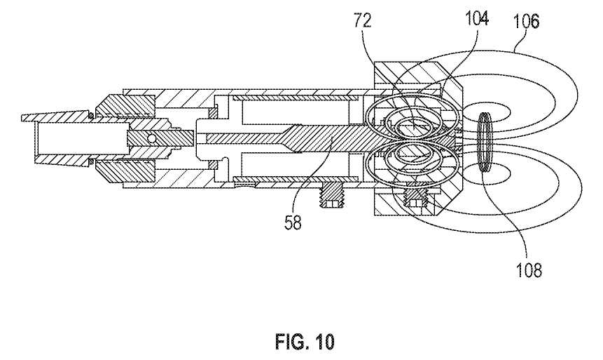

FIG. 10 depicts an exemplary embodiment of handpiece 16 comprising a second coil. Another way to produce smooth startup in handpiece 16 including a permanent magnet (i.e., magnet 72) attached to the plunger 58 is to place a second coil 108 of wire at the rear of the handpiece 16. The second coil potentially includes a large series inductance to prevent rapid current change caused by the movement of the magnet 72 in proximity to this second coil 108. The second coil 108 can push the plunger 58 into the intermediate impact device 48 by repelling the permanent magnet 72 as shown by second coil field 106 and magnet coil 104, When main drive pulses are applied to otherwise enable motion in the piston, the repelling current in the second coil 108 can be reduced until plunger motion is enabled. The process described here and created by the embodiment shown in FIG. 10 can provide a smooth startup process, ending when the current in the second coil 108 is reduced to zero and allowing the plunger 58 to strike the intermediate impact device 48 with full power after each main drive pulse. The process may be fully reversed to provide equally smooth handpiece deactivation.

For handpiece 16 where a permanent magnet (e.g., magnet 72) is affixed to the plunger 58, the startup signal and repulsion coil methods above can work well, because the startup signal can be low current, or low average current, and still drive the plunger 58 into intermediate impact device 48. However, for handpiece 16 that does not have a permanent magnet attached to the plunger 58, these methods will either consume too much power or they will attract the plunger 58, rather than repelling the plunger 58 toward the intermediate impact device 48. For these types of handpieces 16, including plunger 58 comprising basic bare metal made of magnetic metal but not having a permanent magnet attached to the rear of the plunger 58 (though the plunger tip is usually of a different, non-magnetic metal such as aluminum), high power strikes can be achieved, but smooth startup may be difficult to achieve. Yet, some methods of providing smooth startup for handpiece 16 comprising a basic plunger 58 (e.g., without an attached permanent magnet) is to perform startup at a lower strike rate (for example 1,200 strikes-per-minute instead of 2400 strikes-per-minute).

The plunger 58 motion can be slowly increased from a stationary state by increasing the duration of the drive pulses at the slower strike rate until the plunger 58 begins to hammer against the intermediate impact device 48. The onset of the hammering at this lower strike rate can be very smooth. After strong hammering has been established, the duration of the drive pulses can remain constant while the strike rate increases as the pedal displacement or hand control sensor force is increased, leading to more frequent strikes. The higher strike rate can also give the impression of further increased power; indeed, since power can be the rate at which strikes of constant energy are delivered, increasing the strike rate in this case does truly increase power.

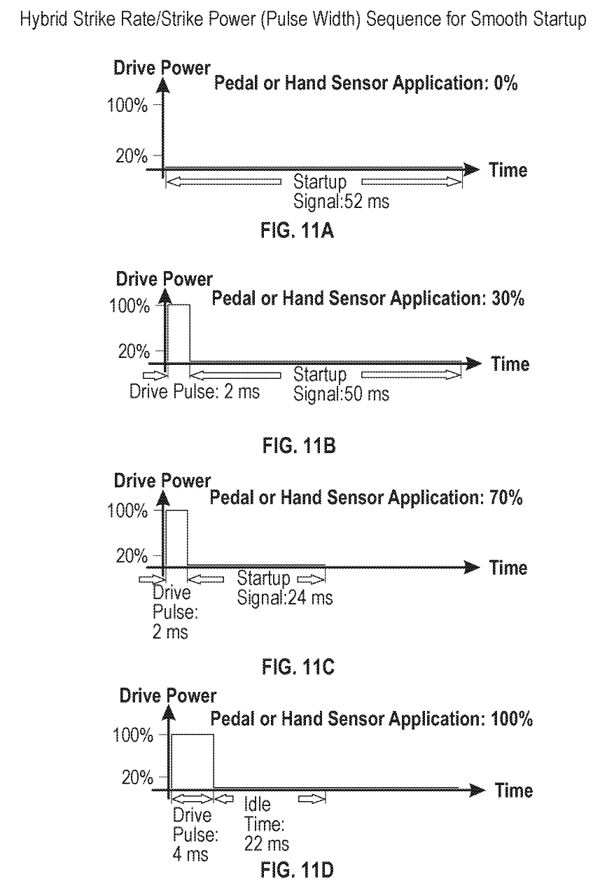

Once the desired strike rate is achieved in this process, the strike rate remains constant, and the drive pulses once again begin to increase in duration upon further displacement in foot pedal 18 or applied force on the control sensor 19. The duration increases to its maximum allowed value as either the pedal 18 or control sensor 19 value is increased toward its maximum value, allowing the handpiece 16 to smoothly reach and maintain maximum power for as long as the user intends. When the foot pedal 18 or control sensor 19 is gradually released, the previously described process reverses itself until the motion of the plunger 58 has stopped. It is important to effect incremental changes to the time between drive pulses when the strike rate is adjusted in order to create an uninterrupted sequence of pulses having a constant duration to control the main drive circuitry for the solenoid 54 coil. It is equally important to maintain the strike rate as the pulse durations are increased or decreased (essentially beginning the drive pulses at regular intervals defined by the strike rate as the pulse durations increase or decrease according to foot pedal 18 or control sensor 19 control inputs). The essential quality of this method is to avoid the hysteresis of plunger 58 engagement with the intermediate impact device 48 at high strike rates by changing the kinetic energy of the plunger 58 between low kinetic energy and high kinetic energy only when the strike rate is low, where plunger 58 bouncing has time to die down before it can significantly influence the motion of the plunger 58 at low kinetic energies, thereby preventing intermittent engagement, or the abrupt onset of periodic engagement of the plunger 58 with the intermediate impact device 48; and by changing the strike rate of the plunger 58 between low strike rates and high strike rates only when the kinetic energy of the plunger 58 is high (where it is striking the intermediate impact device 48 in a stable and periodic manner), where the high kinetic energy of the plunger 58 prevents intermittent engagement of the plunger 58 with the intermediate impact device 48. The waveforms of a drive signal to the solenoid 54 to perform these processes are shown in FIGS. 11A-11D (for startup), and FIGS. 12A-12D (for deactivation). This process can also be accomplished by changing drive pulse voltages while keeping drive pulse durations constant, or by using a hybrid process wherein both drive pulse durations and drive pulse voltages are changed to achieve the smooth startup and deactivation of the handpiece 16. These methods of adjusting the handpiece 16 strike rate during both startup and deactivation of the handpiece 16 to achieve smooth operation work for basic plungers 58 (without magnets attached) as well as for plungers 58 with permanent magnets (i.e., magnet 72) attached

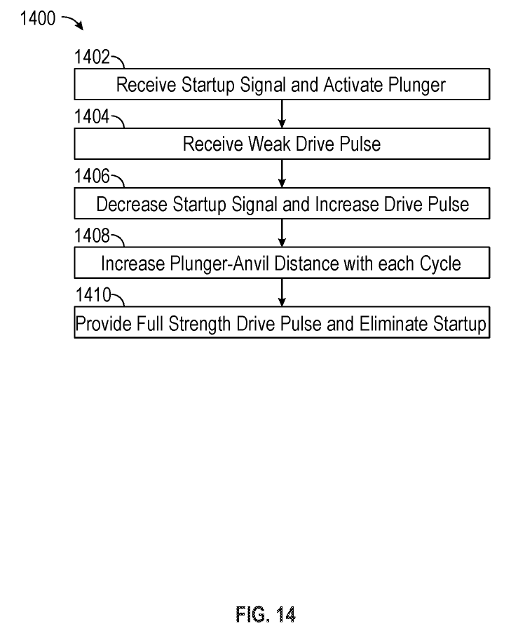

FIG. 14 depicts a flow diagram illustrating an exemplary startup procedure of graver system 10 referenced by numeral 1400. At step 1402, the startup signal may weakly energize the solenoid to provide a weak magnetic field. The weak magnetic field may provide a weak force on plunger 58 to hold plunger 58 against intermediate impact device 48. The startup signal may be provided when power is provided to handpiece 16 by control box 12 but when foot pedal 18 or control sensor 19 is not engaged or at a zero position. At step 1404, as the operator provides input to foot pedal 18, or control sensor 19, a weak drive pulse is transmitted to handpiece 16. At step 1406, simultaneously to step 1404, reduction of the starting signal begins. At step 1408, as the operator continues to press foot pedal 18, or control sensor 19, the starting signal continues to reduce while the drive pulse continues to increase. The two changing signals cause plunger to cycle back and forth to and away from intermediate impact device 48 impacting anvil with each cycle. As the two signals change (i.e., starting signal decreases and drive pulse increases) the distance between plunger 58 and intermediate impact device 48 increases with each cycle. At step 1410, the drive pulse reaches full strength as the starting signal is eliminated. At this point, handpiece 16 has entered normal operation as described in the processes below.

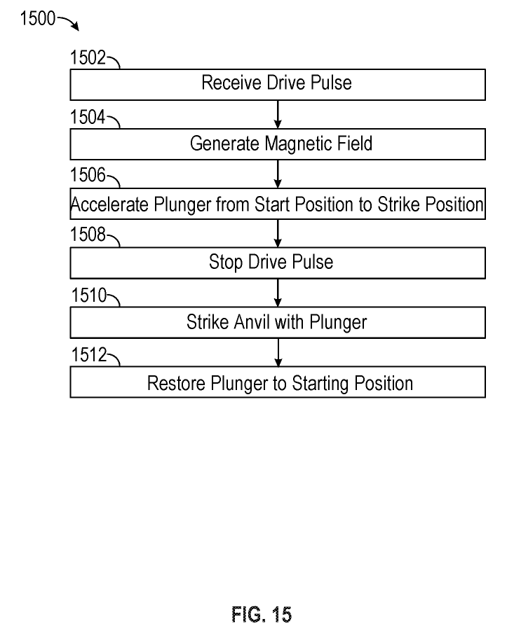

FIG. 15 depicts a flow diagram illustrating an exemplary operation process of handpiece 16 referenced by numeral 1500. The exemplary operation process here illustrates the cyclic phase of engraving after the startup process. At step 1502, solenoid 54 receives the drive pulse. The drive pulse may be provided by control box 12 as described above. Solenoid 54 may receive the full drive pulse after startup signal has dissipated. Upon receipt of the drive pulse, solenoid 54 may be energized to generate the magnetic field at step 1504. The magnetic field may surround solenoid 54 interacting with plunger 58 including magnet 72 as described in embodiments above.

At step 1506, plunger 58 may be accelerated from the start position to the strike position by the force imparted by the magnetic field from solenoid 54. The force comprises at least the force imparted on plunger 58 and the force imparted on magnet 72 as the magnet poles may be aligned with the magnetic field.

At step 1508, drive pulse stops shortly before plunger 58 strikes intermediate impact device 48. The momentum of plunger 58 carries plunger into intermediate impact device 48 optimally striking intermediate impact device 48 at step 1510. As the force has been removed, at step 1512, spring force imparted by spring 70 pulls plunger 58 back to the starting position. Just as plunger reaches back cap screw 76 and plunger is again at start position, operation process begins again. The process repeats, for example, 40 times per second until operator changes the setting of foot pedal 18.

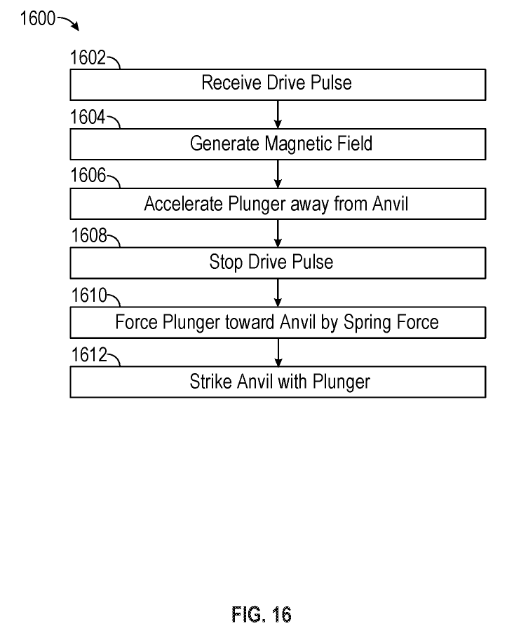

FIG. 16 depicts a flow diagram illustrating an alternative embodiment of the operation of handpiece 16 referenced by numeral 1600. At step 1602, solenoid 54 receives drive pulse. Drive pulse may be provided by control box 12 as described above. Upon receipt of drive pulse, solenoid may be energized to generate magnetic field at step 1604. The magnetic field may surround solenoid interacting with plunger 58.

At step 1606, the force imparted onto plunger 58 by the magnetic field of solenoid 54 accelerates plunger 58 away from intermediate impact device 48 stretching spring 70 from the natural position of spring 70. The force comprises at least the force imparted on plunger 58.

At step 1608, drive pulse stops, and the magnetic field is eliminated. In some embodiments, circuit 92 increases the speed of current decay in solenoid 54. Once there is no longer a force pushing plunger 58 away from intermediate impact device 48, at step 1610, spring force pulls plunger back to the starting position where, at step 1612, plunger 58 strikes intermediate impact device 48. The operation process begins again when the control box 12 has determined the elapsed time has passed and a new drive pulse is required in order to maintain the strike rate selected by the user.

Clause 1. A graver handpiece for engraving. The graver handpiece comprises a solenoid configured to generate a magnetic field when energized.

Clause 2. The graver handpiece of clause 1, further comprising a plunger positioned adjacent to the solenoid.

Clause 3. The graver handpiece of clause 2, further comprising a magnet coupled to a back end of the plunger.

Clause 4. The graver handpiece of clause 3, wherein the plunger is configured to accelerate toward an intermediate impact device under a force imparted on the plunger by the magnetic field of the solenoid.

Clause 5. The graver handpiece of clause 4, wherein the plunger is configured to strike the intermediate impact device transferring at least a portion of the force to the intermediate impact device for engraving.

Clause 6. The graver handpiece of clause 5, further comprising a back cap configured to adjust a starting position of the plunger.

Clause 7. The graver handpiece of clause 6, further comprising: a spring configured to provide a restoring force to the plunger, wherein the restoring force forces the plunger from a striking position to the starting position of a strike cycle.

Clause 8. The graver handpiece of clause 7, further comprising: an all-metal housing and one or more vent holes provided in the all-metal housing, wherein the one or more vent holes are configured to provide airflow between an exterior of the graver handpiece and an interior of the graver handpiece.

Clause 9. The graver handpiece of clause 8, wherein the one or more vent holes comprises a forward vent hole and an aft vent hole, and wherein when the plunger moves forward air is forced out of the forward vent hole and the air is pulled into the aft vent hole, and wherein when the plunger moves backward, air is forced out the aft vent hole and the air is pulled in through the forward vent hole.

Clause 10. The graver handpiece of clause 6, further comprising: a thermally insulated housing; and one or more vent holes provided in the thermally insulated housing.

Clause 11. The graver handpiece of clause 10, wherein, upon movement of the plunger, air is forced into and out of an interior of the graver handpiece through the one or more vent holes.

Clause 12. The graver handpiece of clause 11, further comprising dampening material on the back cap of housing configured to absorb energy from the plunger during a return stroke.

Clause 13. The graver handpiece of clause 5, wherein the solenoid is configured to provide a weak magnetic field when a startup signal is received, and wherein the weak magnetic field causes the plunger to contact the intermediate impact device and stay in contact with the intermediate impact device with the magnet providing a reduction in current needed for the weak magnetic field.

Clause 14. The graver handpiece of clause 5, wherein the solenoid is configured to provide a changing magnetic field, and wherein the changing magnetic field is turned on and off during startup to accelerate the plunger to a desired cycle duration and impact force.

Clause 15. The graver handpiece of clause 5, further comprising: an intermediate housing threaded into a central housing, wherein a distance that the intermediate housing is threaded into the central housing defines a distance and travel time of the plunger from a cycle starting position to a cycle striking position.

Clause 16. A graver handpiece for engraving. The graver handpiece comprising a solenoid configured to generate a magnetic field when energized.

Clause 17. The method of clause 16, further comprising a plunger positioned adjacent to the solenoid.

Clause 18. The method of clause 17, further comprising a spring configured to impart a spring force on the plunger.

Clause 19. The method of clause 18, wherein the plunger is configured to accelerate away from an intermediate impact device under a force imparted on the plunger by the magnetic field of the solenoid.

Clause 20. The method of clause 19, wherein the plunger is configured to strike the intermediate impact device with a forward end of the plunger transferring at least a portion of the force to the intermediate impact device.

Clause 21. A method of operating a graver handpiece. The method comprises receiving a drive pulse by a solenoid.

Clause 22. The method of clause 21, further comprising generating a magnetic field by the solenoid based on the drive pulse.

Clause 23. The method of clause 22, further comprising imparting a force onto a plunger by the magnetic field.

Clause 24. The method of clause 23, further comprising estimating an impact time of the plunger.

Clause 25. The method of clause 24, further comprising eliminating the magnetic field at or near the impact time based on an input from a hand control or a pedal.

Clause 26. The method of clause 25, further comprising forcing the plunger away from an intermediate impact device by a spring force from a spring coupled to the plunger.

Clause 27. The method of clause 26, further comprising imparting a magnetic force on a magnet coupled to the plunger, wherein the force imparted onto the plunger includes the magnetic force.

Clause 28. The method of clause 27, further comprising stopping the plunger from moving away from the intermediate impact device by striking a back cap adjustable screw.

Clause 29. The method of clause 28, wherein a distance traveled by the plunger from the intermediate impact device to the back cap adjustable screw is defined by a setting of the back cap adjustable screw and a solenoid position via a solenoid set screw and is based on a strike force and a strike time of the plunger on the intermediate impact device.

Clause 30. The method of clause 26, further comprising: receiving a startup signal by the solenoid; holding the plunger in contact with the intermediate impact device by a force generated based on the startup signal; and moving the plunger away from the intermediate impact device and back to the intermediate impact device in a cyclic motion based on the startup signal and the drive pulse, wherein a distance between the plunger and the intermediate impact device increases with each cycle.

Clause 31. The method of clause 30, further comprising: receiving, by the pedal, a user continuous input from a user; and generating, by the pedal, the startup signal based on a continuous input from the user.

Clause 32, The method of clause 30, further comprising: receiving, by a handpiece input, a user continuous input from a user; and generating the startup signal in the solenoid based on a continuous input from the user.

Clause 33. The method of clause 26, further comprising: providing vent holes through a housing; forcing heated air from an interior of the housing to an exterior of the housing by the plunger moving in a first direction; and pulling cool air into the interior of the housing from the exterior of the housing by the plunger moving in a second direction.

Although the invention has been described with reference to the embodiments illustrated in the attached drawing figures, it is noted that equivalents may be employed, and substitutions made herein without departing from the scope of the invention.

Having thus described various embodiments of the disclosure, what is claimed as new and desired to be protected by Letters Patent includes the following:

1. A graver handpiece for engraving, the graver handpiece comprising:
a solenoid configured to generate a magnetic field when energized;
a plunger positioned adjacent to the solenoid; and
a magnet coupled to a back end of the plunger;
wherein the plunger is configured to accelerate toward an intermediate impact device under a force imparted on the plunger by the magnetic field of the solenoid, and
wherein the plunger is configured to strike the intermediate impact device transferring at least a portion of the force to the intermediate impact device for engraving.

2. The graver handpiece of claim 1, further comprising a back cap configured to adjust a starting position of the plunger.

3. The graver handpiece of claim 2, further comprising:
a spring configured to provide a restoring force to the plunger,
wherein the restoring force forces the plunger from a striking position to the starting position of a strike cycle.

4. The graver handpiece of claim 2, further comprising:
an all-metal housing and one or more vent holes provided in the all-metal housing,
wherein the one or more vent holes are configured to provide airflow between an exterior of the graver handpiece and an interior of the graver handpiece.

5. The graver handpiece of claim 4,
wherein the one or more vent holes comprises a forward vent hole and an aft vent hole,
wherein when the plunger moves forward air is forced out of the forward vent hole and the air is pulled into the aft vent hole, and
wherein when the plunger moves backward, air is forced out the aft vent hole, and the air is pulled in through the forward vent hole.

6. The graver handpiece of claim 2, further comprising:
a thermally insulated housing; and
one or more vent holes provided in the thermally insulated housing.

7. The graver handpiece of claim 6, wherein upon movement of the plunger, air is forced into and out of an interior of the graver handpiece through the one or more vent holes.

8. The graver handpiece of claim 7, further comprising dampening material on the back cap of housing configured to absorb energy from the plunger during a return stroke.

9. The graver handpiece of claim 1,
wherein the solenoid is configured to provide a weak magnetic field when a startup signal is received, and
wherein the weak magnetic field causes the plunger to contact the intermediate impact device and stay in contact with the intermediate impact device with the magnet providing a reduction in current needed for the weak magnetic field.

10. The graver handpiece of claim 1,
wherein the solenoid is configured to provide a changing magnetic field, and
wherein the changing magnetic field is turned on and off during startup to accelerate the plunger to a desired cycle duration and impact force.

11. The graver handpiece of claim 1, further comprising:
an intermediate housing threaded into a central housing,
wherein a distance that the intermediate housing is threaded into the central housing defines a distance and travel time of the plunger from a cycle starting position to a cycle striking position.

12. A graver handpiece for engraving, the graver handpiece comprising:
a solenoid configured to generate a magnetic field when energized;
a plunger positioned adjacent to the solenoid; and
a spring configured to impart a spring force on the plunger,
wherein the plunger is configured to accelerate away from an intermediate impact device under a force imparted on the plunger by the magnetic field of the solenoid, and
wherein the plunger is configured to strike the intermediate impact device with a forward end of the plunger transferring at least a portion of the force to the intermediate impact device.

13. A method of operating a graver handpiece, the method comprising:
receiving a drive pulse by a solenoid;
generating a magnetic field by the solenoid based on the drive pulse;
imparting a force onto a plunger by the magnetic field;
estimating an impact time of the plunger;
eliminating the magnetic field at or near the impact time based on an input from a hand control or a pedal; and
forcing the plunger away from an intermediate impact device by a spring force from a spring coupled to the plunger.

14. The method of claim 13, further comprising:
imparting a magnetic force on a magnet coupled to the plunger,
wherein the force imparted onto the plunger includes the magnetic force.

15. The method of claim 13, further comprising stopping the plunger from moving away from the intermediate impact device by striking a back cap adjustable screw.

16. The method of claim 15, wherein a distance traveled by the plunger from the intermediate impact device to the back cap adjustable screw is defined by a setting of the back cap adjustable screw and a solenoid position via a solenoid set screw and is based on a strike force and a strike time of the plunger on the intermediate impact device.

17. The method of claim 13, further comprising:
receiving a startup signal by the solenoid;
holding the plunger in contact with the intermediate impact device by a force generated based on the startup signal; and
moving the plunger away from the intermediate impact device and back to the intermediate impact device in a cyclic motion based on the startup signal and the drive pulse,
wherein a distance between the plunger and the intermediate impact device increases with each cycle.

18. The method of claim 17, further comprising:
receiving, by the pedal, a user continuous input from a user; and
generating, by the pedal, the startup signal based on a continuous input from the user.

19. The method of claim 17, further comprising:
receiving, by a handpiece input, a user continuous input from a user; and
generating the startup signal in the solenoid based on a continuous input from the user.

20. The method of claim 13, further comprising:
providing vent holes through a housing;
forcing heated air from an interior of the housing to an exterior of the housing by the plunger moving in a first direction; and
pulling cool air into the interior of the housing from the exterior of the housing by the plunger moving in a second direction.
